(19) United States
(12) Patent Application Publication
(10) Pub. No.: US 2012/0187007 A1
(43) Pub. Date: Jul. 26, 2012

(54) CATERING KITCHEN DEVICE

(75) Inventors: Raimond Gatter, Uznach (CH); Patrick Steiger, Villmergen (CH)

(73) Assignee: ELRO (HOLDING) AG, Bremgarten (CH)

(21) Appl. No.: 13/395,166

(22) PCT Filed: Sep. 10, 2010
(86) PCT No.: PCT/EP2010/063309

§ 371 Date: Apr. 10, 2012

(30) Foreign Application Priority Data
Sep. 11, 2009 (CH) 01415/09

(51) Int. Cl. B65D 85/00; B23P 11/00

(52) U.S. Cl. 206/223; 29/428

(57) ABSTRACT

The invention relates to a catering kitchen device for arranging in front of or on a wall, comprising at least one inner area defined by device walls, a functional area and at least one supply line arranged in the inner area and for connecting to an external supply connection which is connected to the wall. Said catering kitchen device also comprises a rear wall having a structure which is flexible at least in sections. The at least one supply line passes through an opening arranged in said flexible structure.

### TECHNICAL SCOPE

The present invention relates to a catering kitchen device for arranging in front of or on a wall as claimed in the features of the preamble of claim 1.

### PRIOR ART

In the area of catering kitchen devices (cookers, pressure cookers/braisers, ovens, dishwashers, etc.) it is usual to install said device in a fixed manner in the kitchen. The catering kitchen device is connected in a fixed manner to a wall, for example, or is in contact with the floor, the device then being connected to the wall. At the same time, the catering kitchen devices are connected to supply connections (water, gas, electricity, waste water, etc.) which are present in the wall. The supply connections, in this case, are arranged in a fixed manner on the wall side. In the majority of cases on the device side, flexible supply lines are provided which are then connected to the supply connections arranged on the wall side.

As a result of the fact that the available floor space in a catering kitchen is to be utilized as well as possible, the catering kitchen devices are mounted or set up where possible connecting directly to the wall. In this case, the supply lines have to be connected to the supply connections of the wall before the mounting operation. In this case, the points of connection on the supply lines between the building installation and the appliance are only accessible with difficulty as the distance between the wall and the rear wall of the catering kitchen device is to be kept very small.

To the low level of accessibility can be added that tolerances between the supply connections of the catering kitchen device and those of the building installation have to be compensated. This is usually effected in a non-controlled manner, which leads to mechanical stresses in the supply lines.

In the case of machines when fitting catering kitchens, there has been a move to dispense with a rear wall of the appliance such that, for example, it is possible to compensate for the tolerance in an easier manner. Although this provides a relatively uncomplicated mounting variant for the installer, this solution harbors the disadvantage that water or other liquids are able to flow into the device between the building wall and the device. The ingress of water can result in severe damage to the device and is consequently unwanted. In addition, high pressure cleaners, where the risk of ingress of water is even greater, are used more and more.

### SUMMARY OF THE INVENTION

The object underlying the present invention is to provide a catering kitchen device which overcomes the disadvantages of the prior art. In particular, there is to be provided a catering kitchen device which can be connected to supply connections of the building installation in a simple manner and at the same time, as an option, prevents the ingress of water in an extensive manner.

Such an object is achieved through the features of claim 1. Accordingly, a catering kitchen device for arranging in front of or on a wall comprises at least one inside space which is defined by appliance walls, an operating area and at least one supply line which is arranged in the inside space for connecting to an external supply connection which is connected to the wall. The catering kitchen device additionally comprises a rear wall with a flexible structure which is flexible at least in sections, wherein the at least one supply line is guided through an opening which is arranged in the flexible structure.

The advantage of the catering kitchen device realized in such a manner is that the device can be placed in front of the wall in such a manner that the space between the device and the wall becomes minimal as the points of connection between the supply line and the supply connection can project into the inside space. In addition, tolerances between the supply line of the catering kitchen device and the supply connection are able to be compensated well as a result of the flexible structure.

The rear wall preferably consists of the flexible structure over its entire surface.

As an alternative, the structure which is flexible in sections is arranged in a rigid rear wall, wherein the rigid rear wall has apertures, by means of which the structure which is flexible in sections is mounted.

The sections of the flexible structure are preferably greater by a multiple, preferably within the range of a factor between 2 and 15, particularly preferably 5 and 10, than the cross section of the supply line which is to be guided through.

The flexible structure is preferably resilient matting, a Shore hardness of which is preferably less than 50° Shore.

The flexible structure is preferably provided with a plurality of slots or apertures which are arranged at intervals with respect to each other, wherein the catering kitchen device is provided in the region of the rear wall with a plurality of knob-like elements which can be moved into connection with the slots such that the flexible structure is able to be suspended on the elements.

In a preferred embodiment, the openings comprise reinforcing elements, in particular a disk which is provided with an aperture and which is connected to the flexible section of the rear wall, or a bead which surrounds the opening at least in part.

Parts of the flexible structure are preferably offset into the inside space such that at least one convexity is created for the reception of fastening means of the wall, wherein, the convexity extends over the entire width of the catering kitchen device, or wherein the at least one convexity extends over a section.

Further embodiments are provided in the dependent claims.

### BRIEF DESCRIPTION OF THE DRAWINGS

Preferred embodiments of the invention are described below by way of the drawings which serve simply for explanation and are not to be interpreted in a restricting manner. In the drawings:

FIG. 1 shows a partially sectioned schematic view of an exemplary catering kitchen device during the mounting procedure, the device already being connected to the supply lines of the building installation;

FIG. 2 shows a partially sectioned schematic view of the device according to FIG. 1 after the mounting procedure; and

FIGS. 3a to 3f show several schematic detailed views of the guiding through of the supply lines.

### DESCRIPTION OF PREFERRED EMBODIMENTS

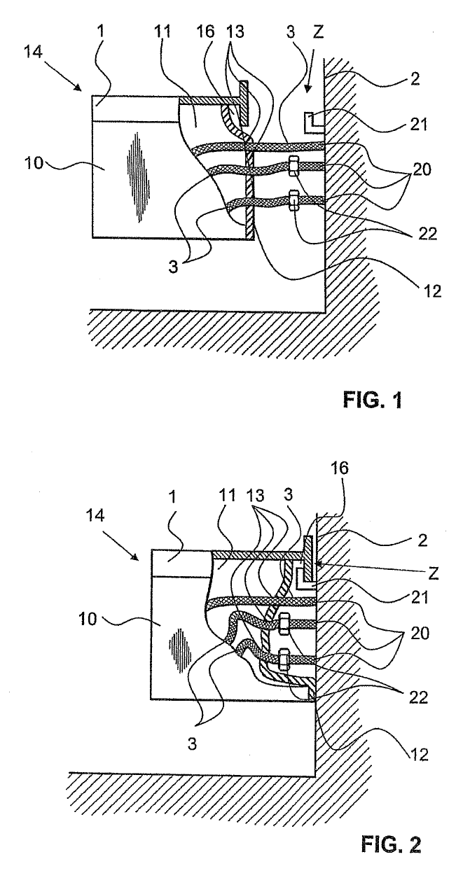

FIG. 1 shows a partially sectioned view of a catering kitchen device 1. The term catering kitchen device 1 refers to all the devices which are used in catering kitchens. For example these can be: cookers, pressure cookers (braisers), boiling vessels, ovens, dishwashers, etc.

The catering kitchen device 1 is to be placed as close as possible to a wall 2 in order to enable as optimum use as possible of the available floor space. This means that a space Z between the catering kitchen device 1 and the wall 2 is to be as small as possible, in particular not present at all. In the case of the latter, the device contacts the wall. In addition, supply lines 3 or media connections of the catering kitchen device 1 are to be connected to supply connections 20 that are present on the wall side. The supply connections 20, in this case, are arranged in and/or on the wall 2 and serve for supplying or conducting away media, such as, for example, fresh water, gas, electricity, waste water, steam, etc. The supply connections 20 further include couplings 22, by means of which the supply lines 3 are connected.

In the present embodiment, the catering kitchen device 1 is connected to the wall 2 by means of a support 21 which is fastened to the wall 2, or is suspended on the support 21. Other types of fastening, such as, for example, a screw connection, are equally conceivable. It is also conceivable for the catering kitchen device to stand on feet, the catering kitchen device being arranged in such a manner in relation to the wall 2 that the space Z between the wall and the catering kitchen device is as small as possible, or for the device to contact the wall. The remaining space Z can be covered by a trim (not shown) which is connected to the wall 2 and/or the catering kitchen device 1.

The catering kitchen device 1 comprises at least appliance walls 10 which define an inside space 11, a rear wall 12 which faces the wall 2 and an operating area 14. The inside space 11 serves for the reception of supply lines 3 and other devices which are not shown here, such as, for instance, control devices, heating devices, etc. The operating area 14 comprises the elements which the user operates when using the catering kitchen device 1 and which enable the catering kitchen device 1 to be used as intended. In the case of a cooker, the cooker plates and input devices, for example, are included by the expression operating area 14.

The supply lines 3 are guided out of the inside space 11 through the rear wall 12 and are connected to the fixedly installed supply connections 20 in the region of the space Z between the catering kitchen device 1 and the wall 2. The rear wall 12 has corresponding openings 13 for guiding through the supply lines 3. Depending on the type of medium to be guided through, the diameter of the supply lines 3 is within the range of between 3 and 30 mm. A variable number of supply lines 3 is present in dependence on the catering kitchen device 1. For example, it is conceivable to provide three water connections, two communication connections and one power connection.

The rear wall 12, as shown in FIG. 2, is realized at least in sections or absolutely totally from a flexible structure, such as, for example, resilient matting. As is clear from the overall context of the application, a flexible structure refers to a structure, the elasticity of which is greater by a multiple than, for example, that of a metal side wall. The modulus of elasticity of the flexible structure, consequently, is small in comparison with metal materials. The realization of the rear wall 12 from a resilient material allows the supply lines 3 to be connected to the supply connections 20 before the catering kitchen device 1 is arranged in front of the wall. When the catering kitchen device 1 is mounted on or directly in front of the wall, the space Z is minimized. During the mounting procedure, the resilient rear wall 12 is deformed, said rear wall, as shown in FIG. 2, being pressed in the direction of the inside space 11. This displacement in the direction of the inside space 11 allows the space Z to be minimized as the points of connection 22 between the supply lines 3 and the supply connections, compared to a rigid rear wall, come to rest not in the space Z but in the inside space 11.

The flexible structure of the rear wall 12 preferably has a Shore hardness of less than 50° Shore and consists of a resilient material such as ethylene-propylene-diene rubber (EPDM), nitrile rubber (NBR), silicone. Other materials with similar characteristics are also conceivable.

The selection of a resilient rear wall 12 has a plurality of advantages. On the one hand, the catering kitchen device 1 can be provided with a rear wall without increasing mounting problems, which provides a structure which is tight with regard to ingressing water and accordingly prevents the ingress of water. On the other hand, mounting tolerances can be compensated in a simple manner. In addition, the space Z for producing the connection between the supply connections and the supply lines 3 is able to be selected larger, which simplifies the mounting procedure enormously. In addition, displacements of the catering kitchen device in relation to the wall are easily compensated by the resilient rear wall.

As already mentioned, two embodiments of the rear wall are conceivable. In the case of the first embodiment, the resilient material or the matting is arranged in sections, the rear wall 12 consisting of a rigid material and the flexible section of the rear wall 12 being fixed in the rear wall by means of corresponding apertures. The edge of the matting is then connected to the rear wall. The aperture in the rear wall, in this case, is greater by a multiple than the supply line to be guided through and the matting is selected to be greater than the aperture. The area of the matting is preferably greater, with reference to the cross section of the supply line, by a factor within the range of between 2 and 15, in particular 5 and 10. In the case of a supply line with a cross section of 4 cm², the area would be selected within the range of between 8 cm² and 60 cm².

In the case of this embodiment it is conceivable to guide one or more supply lines through per flexible section.

In a second embodiment, as is shown in FIGS. 1 and 2, the entire rear wall 12, which closes the access to the inside space 11, consists of the resilient material. In other words, this means that the matting extends over the entire cross section of the rear wall 12. The advantage of this embodiment is that larger tolerances are able to be compensated as a result of the greater span width of the matting in comparison with the first embodiment.

In the case of both embodiments it is important that the transition between the flexible sections of the rear wall 12 and the rigid sections of the rear wall 12 or of the appliance walls 10 are realized in a manner that no water is able to ingress. In this case, it is conceivable that the flexible sections are fastened by way of fastening means, such as screws or rivets, arranged at regular intervals. As an alternative, it is also possible to use an adhesive connection on its own or in combination with the fastening means.

As an alternative, the flexible structure or matting can also be provided with a plurality of slots or apertures which are arranged at intervals with respect to each other, the catering kitchen device then being provided with a plurality of knob-like elements which can be moved into connection with the slots. The flexible structure, in this case, can be suspended on the elements.

As an alternative, a strip which surrounds the flexible section or the flexible rear wall 12 at least in part and is preferably made of metal material can be provided, said strip having a multiple of apertures through which the fastening means can be guided. The strip can be placed onto the surface of the rear wall 12 and thus serves as a fastening part. In this case, the force which emanates from the fastening means is better distributed over the length of the connection and the connection can be improved in this manner.

The type of fastening of the flexible rear wall as claimed in the second embodiment can also provide advantages. It can be recognized in FIG. 1 that there is a convexity 16 present in the upper section of the rear wall 13 facing the operating area 14. This convexity 16 creates space into which fastening elements, such as for example the support 21, are able to project. The convexity 16, in this case, can extend over the entire length of the respective edge of the catering kitchen device 1 or several convexities 16 can be provided extending over the corresponding length only in sections. Where the convexities 16 are arranged in sections, corresponding reception elements are provided which are arranged in a manner offset from the plane of the rear wall into the inside space 11. The rear wall is then fastened to said reception elements.

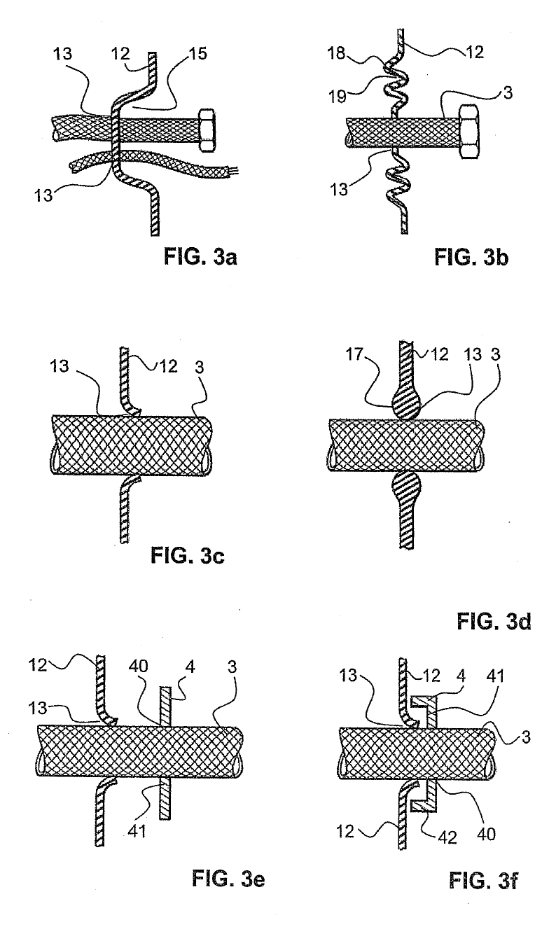

The openings 13 are realized in such a manner that a connection which is tight with regard to ingressing water can also be provided between the supply line 3, which is guided through, and the edge of the opening 13. The cross section of the openings 13 is preferably smaller than the supply lines to be guided through such that a force works on the supply line as a result of the elasticity of the matting. This is shown for example in FIG. 3c where it can be recognized that the matting rests in a sealing manner against the circumference of the supply line 3, part regions of the matting extending along the circumference of the supply line 3.

FIGS. 3a to 3f show embodiments for advantageous developments of the opening 13 in the flexible section of the rear wall or in the flexible rear wall 12.

In the case of the solution shown in FIG. 3a, at least one opening 13, in this case two openings 13, is arranged in a depression or trough 15. The advantage of the depression is that a somewhat larger space is created in the region of the connection between the supply line 3 and the supply connections 20, which improves tolerance with regard to errors in the alignment between the supply connections 20 and the supply line. This means that larger errors are able to be compensated.

FIG. 3b shows a further embodiment of one element which increases the tolerance with regard to errors in the alignment. Elevations 18 or depressions 19, which are arranged in a concentric manner about the openings 13 and are realized with a wave-shaped cross section, are arranged in this case.

In the case of the embodiments according to FIGS. 3a and 3b, larger displacements produced by mechanical movements between the catering kitchen device 1 and the wall 2 can be compensated.

With reference to FIG. 3c, which has already been described above, it is noted here once again that the regions of the flexible section resting on the supply line 3 preferably project in the direction opposite to the inside space 11, that is to say toward the outside. As an alternative, it is also possible for the named regions to project into the inside space 11.

FIG. 3d shows an opening 13, the edge of which is reinforced by an at least partially circumferential bead 17. The inside diameter of the bead 17, in this case, is smaller than the diameter of the supply line 3. As a result of the arrangement of the bead 17, the inside diameter can be selected to be somewhat narrower than in the case of the above embodiments, which increases the tightness between the opening 13 and the supply line 3 even further. In addition, in this case supply lines with a greater weight can also be guided through, it being possible then, nevertheless, to provide a tight connection.

The bead or ring 17 is preferably connected integrally to the matting. In a particularly preferred manner, the bead is realized from a harder material than the matting itself, the harder material being inserted into the matting during the production of the matting and in this way being completely surrounded by said matting. As an alternative, it is also possible for the bead 17 to be produced from the same flexible material as the flexible rear wall. The realization of the bead with a circular cross section in the region which rests on the supply line provides a linear contact between the surface of the supply line and the bead. The linear contact, in this case, has a very positive effect on the sealing action.

The advantage of the ring 17, in addition, is that the coupling or other objects are not pressed into the inside space 11 through the opening 13 in an unintended manner during the mounting procedure.

FIGS. 3e and 3f show further advantageous embodiments. In addition to the above-mentioned developments of the opening, in the named figures the opening 13 according to FIG. 3c is shown, there is arranged a disk 4 with an aperture 40. In this case, the disk 4 serves as a reinforcing element. If the cross sections are circular structures, the disk 4 is essentially realized in a ring-shaped manner. The disk 4, in this case, is arranged in such a manner with respect to the flexible rear wall 12 that the disk 4 is connected to the rear wall 12 by way of the surface 41 which is directed toward the rear wall 12. In this case, the parts of the rear wall 12 or of the opening resting on the surface of the supply line 3 are surrounded by the disk.

The arrangement of a disk increases the tightness of the lead-through as water is able to drip off the disk 4. In addition, the disk also serves as a reinforcing element of the lead-through. In particular in the case of relatively heavy lines, over time the opening 13 can become deformed, the tightness being impaired. By gluing the disk 4 onto the flexible structure, the force of the dead weight of the supply line is taken up not only by the narrow connection between the supply line 3 and the opening 13, but also by the disk 4.

In FIG. 3f the disk has a flange 42 which protrudes beyond the surface 41 and which, in the case of this embodiment, is connected to the rear wall 12. This embodiment essentially serves to protect the connection between the supply line 3 and the rear wall 12.

As an option, the surfaces of the disk 4 which are to be connected to the rear wall 12 are realized in a self-sealing manner such that the disk 4 is able to be connected to the rear wall. Other embodiments are also conceivable, thus, for example, it is also possible to apply an adhesive layer on the rear wall 12.

In the case of both the embodiments of the disk according to FIGS. 3e and 3f, the disk can be arranged on the supply line which is then subsequently guided through the opening 13. Once it has been guided through, the disk is then displaced in the direction of the flexible rear wall 12, where, as an option, it is glued to the rear wall.

### LIST OF REFERENCES

1 Catering kitchen device
2 Wall
3 Supply lines
4 Disk
10 Appliance walls
11 Inside space
12 Rear wall
13 Openings
14 Operating area
15 Trough
16 Convexity
17 Bead
18 Depression
19 Elevation
20 Supply connections
21 Support
22 Coupling
40 Aperture
41 Surface
42 Flange
Z Space

1.-13. (canceled)

14. A catering kitchen device for arranging in front of or on a wall, said device comprising
at least one inside space which is defined by appliance walls and a rear wall;
an operating area;
at least one supply line which is arranged in the inside space for connecting to an external supply connection which is connected to the wall; and
a flexible structure that is arranged in said rear wall, wherein said flexible structure is flexible at least in sections, wherein the at least one supply line is guided through an opening which is arranged in said flexible structure.

15. The catering kitchen device as claimed in claim 14, wherein the rear wall consists of the flexible structure over its entire surface.

16. The catering kitchen device as claimed in claim 14, wherein the flexible structure is arranged in a rigid rear wall, wherein the rigid rear wall has openings, by means of which the structure which is flexible in sections is mounted.

17. The catering kitchen device as claimed in claim 16, wherein the sections of the flexible structure are greater by a multiple than the cross section of the supply line which is to be guided through.

18. The catering kitchen device as claimed in claim 17, wherein said multiple is within the range of a factor between 2 and 15.

19. The catering kitchen device as claimed in claim 17, wherein said multiple is within the range of a factor between 5 and 10.

20. The catering kitchen device as claimed in claim 14, wherein said flexible structure is resilient matting.

21. The catering kitchen device as claimed in claim 14, wherein said flexible structure is resilient matting, a Shore hardness of which is less than 50° Shore.

22. The catering kitchen device as claimed in claim 14, wherein the flexible structure is connected to the rear wall or to the appliance walls in a tight manner with regard to water.

23. The catering kitchen device as claimed in claim 14, wherein the openings surround the respective supply line in a tight manner with regard to water such that ingress of water into the inside space is prevented.

24. The catering kitchen device as claimed in claim 22, wherein, the openings surround the respective supply line in a tight manner with regard to water such that ingress of water into the inside space is prevented.

25. The catering kitchen device as claimed in claim 14, wherein the flexible structure is provided with a plurality of slots or apertures which are arranged at intervals with respect to each other, wherein the catering kitchen device is then provided in the region of the rear wall with a plurality of knob-like elements which can be moved into connection with the slots such that the flexible structure is able to be suspended on the elements.

26. The catering kitchen device as claimed in claim 14, wherein the openings include reinforcing elements.

27. The catering kitchen device as claimed in claim 26, wherein said reinforcing element is choosen from a a disk or a bead, wherein said disk is provided with an aperture and connects to the flexible section of the rear wall or wherein said bead surrounds the opening at least in part.

28. The catering kitchen device as claimed in claim 27, wherein the disk is produced from a material which has a greater rigidity than the flexible section of the rear wall.

29. The catering kitchen device as claimed in claim 27, wherein the region in which the opening is arranged is arranged in a manner offset from the plane of the rear wall in the direction of the inside space such that a trough is created as a result of the offset arrangement.

30. The catering kitchen device as claimed in claim 27, wherein the region in which the opening is arranged is surrounded by a structure, the cross section of which is wave-shaped.

31. The catering kitchen device as claimed in claim 27, wherein parts of the flexible structure are offset into the inside space such that at least one convexity is created for the reception of fastening means of the wall, wherein the convexity extends over the entire width of the catering kitchen device, or wherein the at least one convexity extends over a section.

32. A method for mounting a catering kitchen device as claimed in claim 14 in front of or on a wall, wherein in a first step, the supply lines, which project out through the flexible sections of the rear wall, are connected to the supply connections which are connected to the wall, wherein in a next step, the catering kitchen device is moved toward the wall such that the space between the wall and the rear wall is minimized, wherein during the displacement the flexible sections are displaced toward the inside space of the catering kitchen device.
